(19) United States
(12) Patent Application Publication
(10) Pub. No.: US 2002/0160085 A1
(43) Pub. Date: Oct. 31, 2002

(54) Liquid-absorbent sheet

(75) Inventors: Norihiro Tokita, Kagawa (JP); Akira Shibata, Kagawa (JP); Masahiko Shikatani, Kagawa (JP)

Correspondence Address: DARBY & DARBY P.C., 805 Third Avenue, New York, NY, 10022, US

(73) Assignee: UNI-CHARM CORPORATION

(21) Appl. No.: 10/071,125

(22) Filed: Feb. 8, 2002

(30) Foreign Application Priority Data
Feb. 21, 2001 (JP) 2001-44850

(51) Int. Cl. A23B 4/00

(52) U.S. Cl. 426/124

(57) ABSTRACT

Provided is a liquid-absorbent sheet for absorbing drips oozing from a food. The liquid-absorbent sheet includes a laminate of a liquid-pervious layer and an underlying liquid-absorbing layer. The liquid-pervious layer has through-holes that serve as liquid guides capable of passing the drips therethrough, and the liquid-absorbing layer is capable of absorbing the drips having passed through the liquid-pervious layer. The contact angle of a drop of physiological saline to the surface of the liquid-pervious layer is at least 35°, and the electrostatic chargeability of the liquid-absorbing layer is lower than that of the liquid-pervious layer.

### BACKGROUND OF THE INVENTION

1. Field of the Invention

The present invention relates to a liquid-absorbent sheet to be used under dripping foods.

2. Description of the Related Art

When retailed, fresh foods, especially seafood and meat are put in trays, and the trays with them therein are individually wrapped with a film and placed in showcases.

While put in trays, such seafood and meat ooze drips such as blood. If the drips are left on the trays, they worsen the appearances of the foods in showcases. Especially for meat, if the interface between meat and trays is not aerated, the surface of the meat will be browned. In addition, if the drips are kept in contact with fresh foods for a long stretch of time, bacteria will grow therein.

Accordingly, a breathable, liquid-absorbent sheet capable of absorbing drips oozing from foods is disposed between trays and foods.

As one type of such liquid-absorbent sheet, there has been known a sheet which is made of a liquid-absorbing layer such as nonwoven fabric alone. This type made of such a liquid-absorbing layer alone has the function of rapidly absorbing the drips oozing from fresh foods, but on the other hand, the color of the drips absorbed by the liquid-absorbing layer is still visible. Therefore, they worsen the appearances of the foods. In addition, since the drips absorbed by the liquid-absorbing layer are kept in direct contact with the fresh foods, bacteria will grow in the liquid-absorbent sheet of that type.

As another type of such liquid-absorbent sheet, there has been known a laminate in which a resin film having a large number of through-holes (apertures) formed therein is laminated to a liquid-absorbing layer such as nonwoven fabric. For example, this type of liquid-absorbent sheet is disclosed in Japanese Unexamined Patent Publication No. 323498/1995. By putting fresh foods on the apertured resin film laminated to the surface of the liquid-absorbing layer, the drips once absorbed by the liquid-absorbing layer are prevented from re-adhering to the fresh foods, thereby effectively suppressing the growth of bacteria. In addition, the resin film may have a color-masking function by adding an inorganic filler in the resin film to make it cloudy so that the color of the drips absorbed by the liquid-absorbing layer is hardly visible from the side of foods.

However, such liquid-absorbent sheet having the apertured resin film laminated to the liquid-absorbing layer is problematic in that the drips oozing from fresh foods often remain on the surface of the resin film. Considerable drips from fresh foods, if having adhered to the surface of the resin film, will have an unfavorable impression on consumers because the freshness of the foods on the sheet is seen lower than actually.

For making the drips hardly remain thereon, the resin film may be so modified that each through-hole have a larger open area. By making the open area of each through-hole larger, the contact area between the resin film and the food put thereon is reduced. In addition, the area ratio of the through-holes in the resin film becomes larger, thereby facilitating passage of liquid to the liquid-absorbing layer. However, the resin film having such large through-holes is disadvantageous in that the drips having adsorbed by the liquid-absorbing layer will readily leak back to the surface of the resin film. In addition, even if the resin film is made cloudy so that it may have a color-masking function, the color of the drips having absorbed by the liquid-absorbing layer will be seen through the large through-holes of the resin film.

Another proposal for making the drips hardly remain on the resin film, not enlarging the through-holes in the film, is to reduce or omit the surfactant in the resin film surface to thereby enhance the water repellency of the film surface. The advantage of the resin film of higher water repellency is that the drips given to the surface of the resin film well run on it to reach the through-holes so that they can be attracted and absorbed by the liquid-absorbing layer owing to its capillary action through the through-holes.

However, this proposal is not good for the following reasons. The surfactant in ordinary absorbent sheets has the function of preventing the sheets from being electrostatically charged. Therefore, if the surfactant in the resin film is reduced or omitted so as to enhance the water repellency of the film as in the proposal, the film surface will be electrostatically charged to attract dust in air. During storage or so, accordingly, the film surface will be soiled with dust in storage.

### SUMMARY OF THE INVENTION

The present invention has been worked out in view of the shortcoming in the prior art set forth above. It is therefore an object of the present invention to provide a liquid-absorbent sheet comprising a liquid-pervious layer and a liquid-absorbing layer, of which the advantages are that the amount of drips to remain on the surface of the liquid-pervious layer is reduced and the liquid-pervious layer is prevented from being electrostatically charged to catch dust in air.

According to the present invention, there is provided a liquid-absorbent sheet for absorbing drips oozing from a food, comprising a laminate of a liquid-pervious layer and an underlying liquid-absorbing layer, the liquid-pervious layer having through-holes that serve as liquid guides capable of passing the drips therethrough, the liquid-absorbing layer being capable of absorbing the drips having passed through the liquid-pervious layer,

wherein the contact angle of a drop of physiological saline to the surface of the liquid-pervious layer is at least 35°, and the electrostatic chargeability of the liquid-absorbing layer is lower than that of the liquid-pervious layer.

Preferably, the liquid-pervious layer is in close contact with the liquid-absorbing layer.

The liquid-pervious layer may be a resin film having a plurality of through-holes formed therein, a nonwoven fabric or a network-structured sheet. For example, the liquid-pervious layer is a resin film having a plurality of through-holes formed therein, and the liquid-absorbing layer is processed to have holes that communicate with the through-holes of the liquid-pervious layer.

The liquid-absorbing layer may be a liquid-retentive fibrous layer that comprises at least either of natural fibers and synthetic fibers. Preferably, an antistatic agent is applied to the fibers of the liquid-absorbing layer.

Preferably, the electrostatic chargeability of the laminate of the liquid-pervious layer and the liquid-absorbing layer is lower than that of the liquid-pervious layer alone.

The liquid-pervious layer may comprise a top layer to directly receive a food on one side thereof and at least one back layer laminated to the other side of the top layer, and the electrostatic chargeability of the back layer may be lower than that of the top layer. In this case, it is preferred that the electrostatic chargeability of the top layer is higher than those of the back layer and the liquid-absorbing layer. In addition, at least the back layer and the liquid-absorbing layer may contain an antistatic agent. It is also preferred that the electrostatic chargeability of the laminate of the liquid-pervious layer and the liquid-absorbing layer is lower than that of the top layer alone.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is a perspective view showing a state where the liquid-absorbent sheet is laid on a bottom of a food tray;

FIGS. 2A and 2B are partially-cut, enlarged perspective views showing a liquid-absorbent sheet according to a first embodiment of the invention;

FIG. 3 is a partially-cut, enlarged perspective view showing a liquid-absorbent sheet according to a second embodiment of the invention;

FIGS. 4A and 4B show examples of the cross-sectional profile of a through-hole;

FIGS. 5A and 5B are partially-cut, enlarged perspective views corresponding to the first and second embodiments, respectively;

FIG. 6 is an explanatory view indicating the surface contact angle;

FIG. 7 is a graph showing the relationship between surface contact angle and liquid retention; and

FIG. 8 is a graph showing the relationship between surface contact angle and width of surface liquid absorption of different liquid-absorbent sheets.

### DESCRIPTION OF THE PREFERRED EMBODIMENTS

The present invention will be discussed hereinafter in detail in terms of the preferred embodiment according to the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to avoid unnecessary obscurity of the present invention.

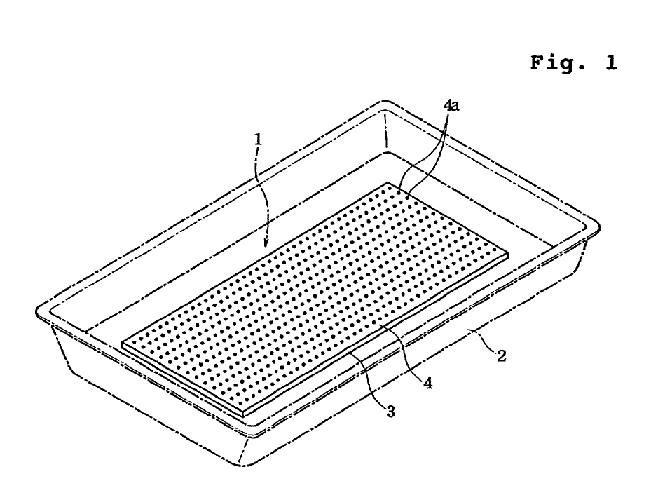

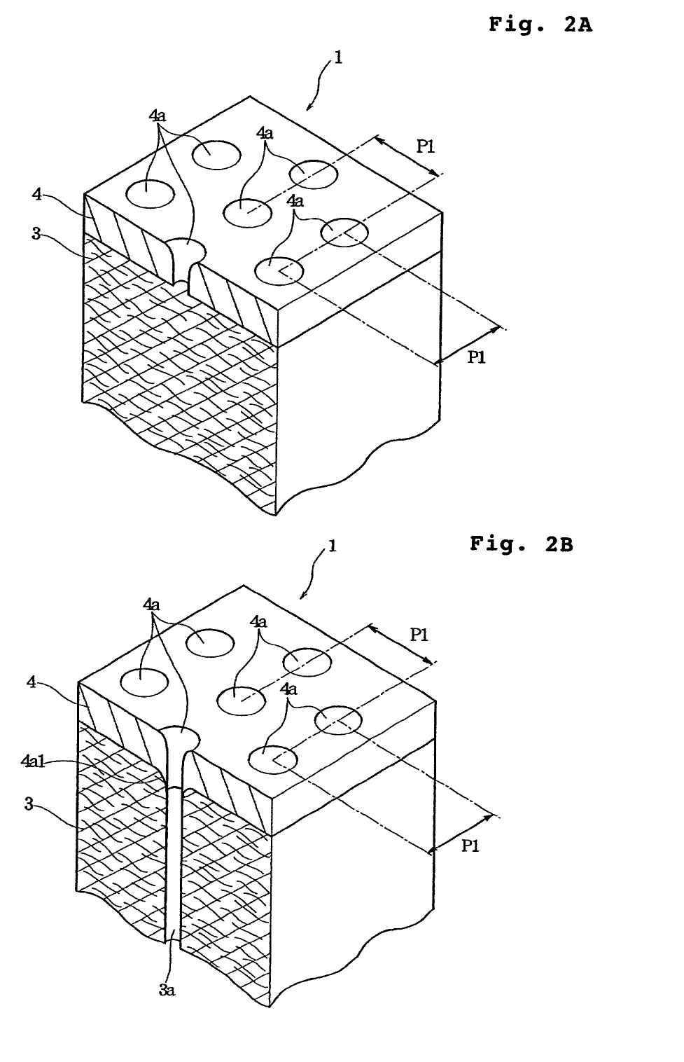

FIG. 2A is a partially-cut, enlarged perspective view showing a portion of a liquid-absorbent sheet 1 according to a first embodiment of the invention. FIG. 1 is a perspective view showing a state where the liquid-absorbent sheet 1 is laid on the bottom of a food tray 2 so that a fresh food such as raw meat or raw fish (not shown) can be put on the liquid-absorbent sheet 1. In general, the upper open end of the food tray 2 with such a fresh food therein is covered with a wrapping film for sale.

The liquid-absorbent sheet 1 is formed by laminating a liquid-pervious layer 4 to a liquid-absorbing layer 3. The liquid-pervious layer 4 is formed from a thermoplastic resin film. The resin film may be a single-layered or multi-layered film of, for example, LDPE (low-density polyethylene), MDPE (middle-density polyethylene), HDPE (high-density polyethylene), LLDPE (linear low-density polyethylene), PP (polypropylene), PET (polyethylene terephthalate) or EVA (ethylene-vinyl acetate copolymer). The thickness of the resin film to form the liquid-pervious layer 4 may fall between 1 and 70 μm, but preferably between 30 and 70 μm.

Containing an inorganic filler such as titanium oxide (TiO₂), calcium carbonate or barium sulfate, or an organic filler, in a ratio by weight falling between 0.1 and 30%, the resin film to form the liquid-pervious layer 4 is cloudy so that it may mask the color of the drips absorbed by the underlying liquid-absorbing layer 3.

The liquid-pervious layer 4 is formed with a large number of through-holes 4a that serve as liquid guides. These through-holes 4a may be arranged regularly or irregularly. In the embodiment shown in FIG. 2A, the through-holes 4a are formed prior to lamination of the resin film to the liquid-absorbing layer 3. However, it is, of course, possible to form the through-holes 4a after lamination of the resin film to the liquid-absorbing layer 3. FIG. 2B shows a case where after the resin film is laminated to the liquid-absorbing layer 3, the through-holes 4a are formed such that heated or non-heated needles are stuck through the resulting laminate from the lower side of the liquid-absorbing layer 3 and then pulled out of it toward the lower side of the liquid-absorbing layer 3. In this case, as shown in FIG. 2B, the resin of the layer 4 partly penetrates into the liquid-absorbing layer 3 to form a liquid guide area 4a1 around each through-hole 4a. In particular, when heated needles are used, the liquid-absorbing layer 3 will certainly be formed with holes 3a that communicate with the respective through-holes 4a corresponding to them. In the sheet of FIG. 2(B) in which the liquid-absorbing layer 3 has the holes 3a formed therein, the liquid applied to the surface of the liquid-pervious layer 4 is more readily absorbed by the liquid-absorbing layer 3 through the through-holes 4a and the holes 3a.

The liquid-absorbing layer 3 is a fibrous layer capable of absorbing and retaining liquid therein owing to the capillary action between fibers and/or the hydrophilic nature of individual fibers. The liquid-absorbing layer 3 may be a nonwoven fabric of synthetic fibers, which is formed to have low density and high liquid retentiveness. For example, the nonwoven fabric may be made of thermoplastic synthetic fibers in a through-air bonding process. Here, examples of the synthetic fibers include monocomponent fibers (fibers made of a single resin alone) and sheath/core or side-by-side bicomponent fibers of which components are made of different resins. Preferably, the synthetic fibers are so designed that a resin appearing on the fiber surface (i.e., the resin forming the monocomponent fibers, the resin forming the sheath component of the sheath/core bicomponent fibers, or the resin forming one component of the side-by-side bicomponent fibers) has a melting point identical or similar to that of the resin forming the liquid-pervious layer 4. This results in facilitating the bonding of the liquid-pervious layer 4 to the liquid-absorbing layer 3, when the resin film for the liquid-pervious layer 4 is thermally bonded or laminated to the liquid-absorbing layer 3, or when the resin film for the liquid-pervious layer 4 is formed on the surface of the liquid-absorbing layer 3 by extrusion laminating. For example, in case where the resin film for the liquid-pervious layer 4 is made of polyethylene, the liquid-absorbing layer 3 is preferably a through-air bonded nonwoven fabric of sheath/core bicomponent fibers, of which the core component is PET and the sheath component is PE, for ensuring good bonding of the layers 3 and 4.

For the liquid-absorbing layer 3, also usable are any of nonwoven fabric that comprises hydrophilic synthetic fibers and hydrophilic natural fibers such as pulp or rayon, air-laid pulp, paper of pulp alone, and paper of pulp and rayon combined.

The basis weight of the liquid-absorbing layer 3 may fall between 10 and 100 g/m²; and the thickness thereof may fall between 0.1 and 5.0 mm.

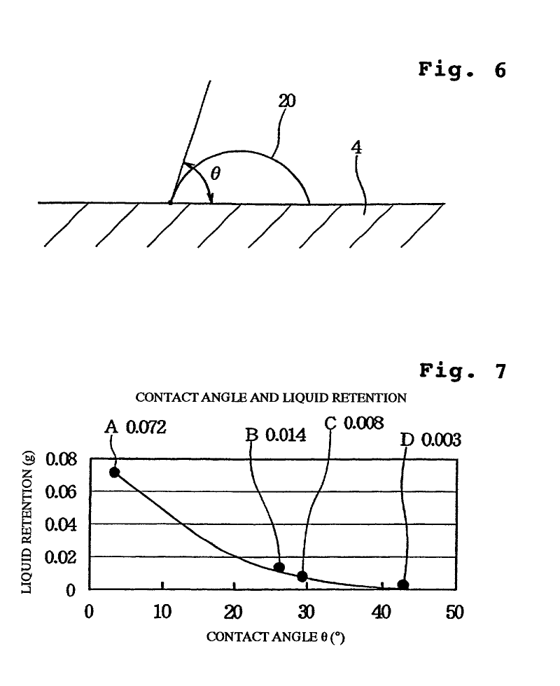

The liquid-pervious layer 4 is so designed that the surface of the resin film for it is water-repellent, and, when 1.8 μl of 0.9% physiological saline is dropped onto the resin film and when the surface contact angle θ between the liquid drop and the resin film is measured, the angle θ is at least 35° (see FIG. 6). To realize its water repellency as above, the resin film made of a thermoplastic resin is not coated with a surfactant; or even if it is coated with a surfactant or contains a surfactant, the amount of the surfactant shall be extremely small so as to attain the surface contact angle θ of at least 35°.

Since the liquid-pervious layer 4 is water-repellent, however, its surface will be readily electrostatically charged when it is rubbed in dry air. To solve this problem, the electrostatic chargeability of the liquid-absorbing layer 3 is made lower than that of the liquid-pervious layer 4. In that condition, the electrostatic charge received by the liquid-pervious layer 4 can be led to the liquid-absorbing layer 3 to thereby lower the degree of electrostatic charge on the surface of the layer 4, and, as a result, the layer 4 is prevented from adsorbing much dust thereon.

In particular, when the resin film for the liquid-pervious layer 4 is thermally bonded or laminated to the liquid-absorbing layer 3, or when the resin film for the liquid-pervious layer 4 is formed on the surface of the liquid-absorbing layer 3 by extrusion laminating, the two layers 3 and 4 can be kept in close contact with each other so that the electrostatic charge received by the layer 4 can be readily led to the layer 3. Especially when the resin film for the liquid-pervious layer 4 is formed by extrusion laminating as set forth, the resin film at the time of formation is in molten state, so that the fibers constituting the layer 3 enter the molten resin film to thereby enhance contact between the liquid-absorbing layer 3 and the liquid-pervious layer 4. In that condition, the electrostatic charge can readily move from the layer 4 toward the layer 3, and the degree of electrostatic charge on the surface of the liquid-pervious layer 4 is thereby lowered.

Accordingly, suitably selecting the materials for the liquid-pervious layer 4 and the liquid-absorbing layer 3 makes it possible to lower the electrostatic chargeability of the entire laminate of the liquid-absorbing layers 3 and the liquid-pervious layer 4 than that of the liquid-pervious layer 4 alone, and, as a result, the degree of electrostatic charge on the surface of the liquid-pervious layer 4 can be thereby lowered.

For leading the electrostatic charge on the liquid-pervious layer 4 to the liquid-absorbing layer 3 and/or for lowering the degree of electrostatic charge on the entire laminate of the liquid-absorbing layers 3 and the liquid-pervious layer 4, the charge level of the liquid-absorbing layer 3 is preferably at most 1/50 of that of the liquid-pervious layer 4, more preferably at most 1/500, even more preferably at most 1/1000.

For lowering the charge level (electrostatic chargeability) of the liquid-absorbing layer 3, it is desirable that the liquid-absorbing layer 3 contains hydrophilic fibers or electroconductive fibers. Alternatively, it is desirable that the constituent fibers of the liquid-absorbing layer 3 are coated with a surfactant to thereby make them hydrophilic, or they are coated with an antistatic agent except surfactant or with an electroconductive resin. If desired, the surface of the liquid-absorbing layer 3 may be coated with a surfactant, an antistatic agent except surfactant, or an electroconductive resin.

The advantage of the liquid-absorbing layer 3 of the type that comprises hydrophilic fibers or surfactant-coated fibers is that moisture in air can readily adhere to the surface of each constituent fiber of the layer 3 to thereby make the fiber surface electroconductive, and as a result, the electrostatic charge on the liquid-pervious layer 4 can be more readily led to the liquid-absorbing layer 3. In addition, the surfactant applied to the fibers makes the fiber surface smoother, thereby reducing the fiber-to-fiber friction that causes static electrification of fibers.

The advantage of the electroconductive fibers or electroconductive resin-coated fibers is that the liquid-absorbing layer 3 comprising the fibers facilitates the movement of the electrostatic charge from the surface of the liquid-pervious layer 4 toward the liquid-absorbing layer 3, and, as a result, the surface of the liquid-pervious layer 4 is prevented from being electrostatically charged.

The surfactant having such an antistatic function may be any of nonionic surfactants such as polyoxyethylene alkylamines, polyoxyethylene alkylamides, polyoxyethylene alkyl ethers, polyoxyethylene alkylphenyl ethers, glycerin fatty acid esters, sorbitan fatty acid esters; anionic surfactants such as alkylsulfonates, alkylbenzenesulfonates, alkylsulfates, alkylphosphates; cationic surfactants such as quaternary ammonium chlorides, quaternary ammonium sulfates, quaternary ammonium nitrates; and ampholytic surfactants such as alkylbetaines, alkylimidazolines, alkylalanines.

The electroconductive resin includes, for example, polyvinylbenzyne cations and polyacrylic acid cations.

In the liquid-absorbent sheet 1 of FIG. 2A, the drips given to the surface of the liquid-pervious layer 4 are absorbed by the liquid-absorbing layer 3 via the through-holes 4a. Concretely, when the drips given to the surface of the resin film of the layer 4 are brought into contact with the liquid-absorbing layer 3 via the through-holes 4a, they are absorbed by the layer 3 owing to the capillary action or the hydrophilic nature of the constituent fibers of the layer 3. Here, because the surface of the resin film forming the liquid-pervious layer 4 is water-repellent, as so designed that the surface contact angle θ between the resin film surface and a liquid drop put thereon is at least 35°, the drips given to the resin film surface readily run and flow thereon. Accordingly, the drips given to the resin film surface can be readily attracted and absorbed by the liquid-absorbing layer 3 via the through-holes 4a. As a result, the drips hardly remain on the resin film surface.

With the holes 3a formed in the liquid-absorbing layer 3, as shown in FIG. 2B, the drip penetration into the liquid-absorbing layer 3 can be further improved as the through-holes 4a individually communicate with the respective holes 3a.

The area ratio of the through-holes 4a in the liquid-pervious layer 4 may fall between 0.1 and 80%. However, since the surface of the layer 4 is water-repellent as so mentioned hereinabove, the drips give thereto could be readily absorbed by the liquid-absorbing layer 3 via the through-holes 4a and therefore hardly remain on the surface of the layer 4, even if the area ratio of the through-holes 4a is small. Accordingly, in case where the liquid-pervious layer 4 is an apertured resin film, the drips given thereto hardly remain on the film surface even if the area ratio of the through-holes 4a in the layer 4 is not larger than 10% and even not larger than 6% or so. If the area ratio of the through-holes 4a in the layer 4 is made so small, the drips once absorbed by the liquid-absorbing layer 3 are prevented from leaking back to the surface of the liquid-pervious layer 4. In addition, the masking effect of the color of the drips absorbed by the liquid-absorbing layer 3 due to cloudiness of the resin film can be increased.

As described hereinabove, the area ratio of the through-holes 4a in the layer 4 may fall between 0.1 and 80% from the viewpoint of the function of the liquid-pervious layer 4. On the other hand, the mean value of the pitch P1 of the through-holes 4a may fall between 0.1 and 15 mm, and the open area of each through-hole 4a may fall between 0.008 and 20 mm², but most preferably between 0.1 and 2 mm².

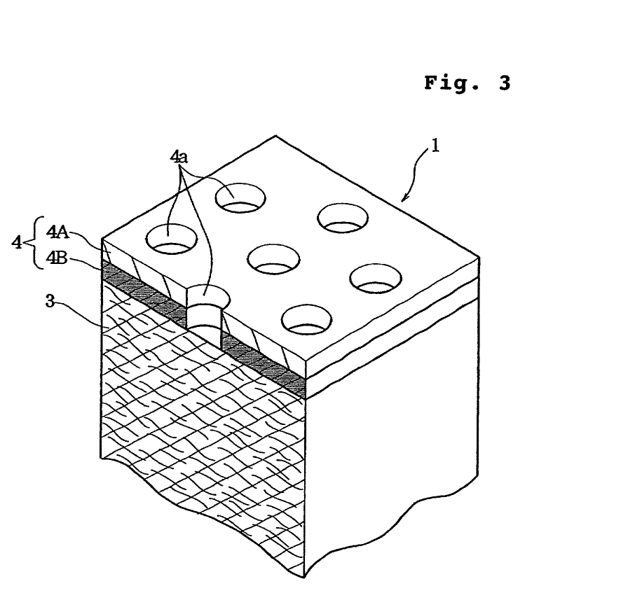

FIG. 3 is an enlarged perspective view showing a portion of a liquid-absorbent sheet according to a second embodiment of the invention. In this second embodiment, the liquid-pervious layer 4 has a two-layered structure, comprising a top layer 4A on which a food is directly put, and at least one back layer 4B laminated to the lower side of the top layer 4A. Both the top layer 4A and the back layer 4B are made of a resin film. The two layers 4A and 4B may be partly bonded to each other, or may be wholly bonded to each other. For the latter, the resins for the two layers 4A and 4B may be co-extruded both in molten state. Especially for facilitating the discharging of the top layer 4A toward the back layer 4B, it is desirable that the two layers 4A and 4B are wholly bonded to each other at their entire interface. In this embodiment, the through-holes 4a serving as liquid guides in the layer 4 run through both the top layer 4A and the back layer 4B, as illustrated.

In the liquid-pervious layer 4 of this embodiment, moreover, the charge level (electrostatic chargeability) of the back layer 4B is lower than that of the top layer 4A. For example, the surface of the top layer 4A is not coated with a surfactant, or the amount of the surfactant, if any, in the top layer 4A is small. In that condition, the surface contact angle θ of the top layer 4A is at least 35°. On the other hand, at least either one of the upper and lower sides of the back layer 4B is coated with a surfactant or an electroconductive resin such as that mentioned hereinabove, or the back layer 4B contains such a surfactant or an electroconductive resin inside it. If desired, the back layer 4B may be made of an electroconductive resin containing an electroconductive filler.

Also in this case, the liquid-absorbing layer 3 is coated with a surfactant or an electroconductive resin so that its charge level could be low. Concretely, the charge level of the liquid-absorbing layer 3 is lower than that of the back layer 4B. Preferably, the chargeability of the laminate of the liquid-absorbing layer 3 and the liquid-pervious layer 4 is lower than that of the top layer 4A alone.

In the embodiment of FIG. 3, since the surface of the top layer 4A on which a food is directly put is water-repellent, the drips given thereto hardly remain on it. In addition, the electrostatic charge on the top layer 4A is readily led to the back layer 4B and then to the liquid-absorbing layer 3. Therefore, the surface of the top layer 4A hardly adsorbs dust in air.

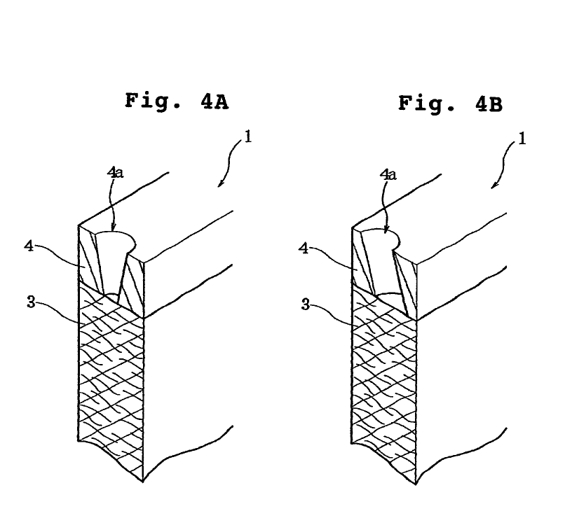

In the first and second embodiments shown in FIGS. 2A and 2B and FIG. 3, the cross-sectional profile of the inner peripheral wall of each through-hole 4a may be tapered toward the liquid-absorbing layer 3, as in FIG. 4A; or may run obliquely toward the liquid-absorbing layer 3, as in FIG. 4B.

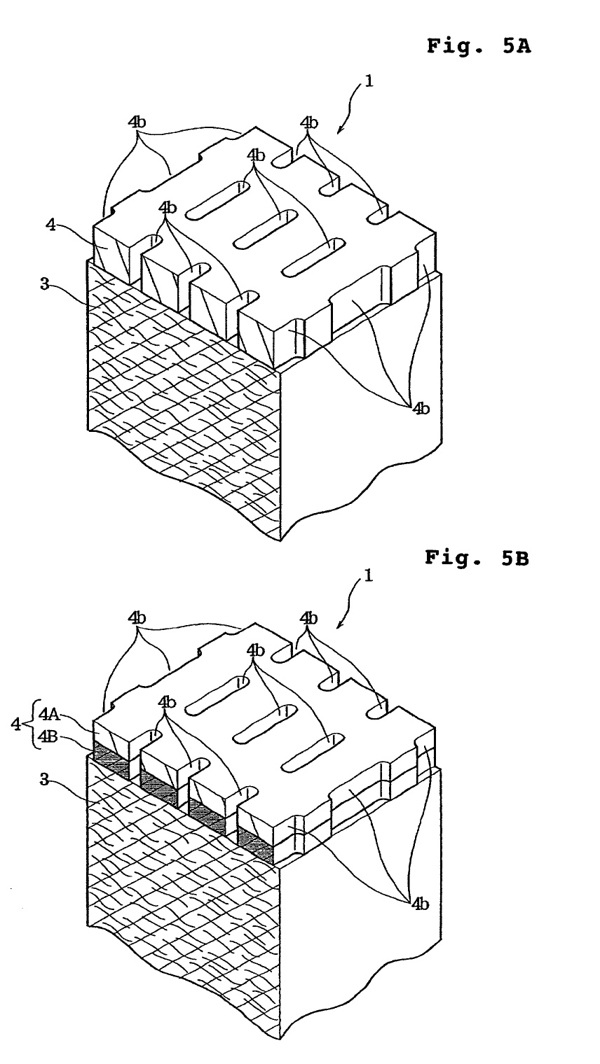

As shown in FIGS. 5A and 5B, on the other hand, the through-holes in the liquid-pervious layer 4 may be in the form of narrow slits 4b. Also in this case, the cross-sectional profile of the inner peripheral wall of each slit 4b may run perpendicularly toward the liquid-absorbing layer 3, or may be tapered toward it, or may run obliquely toward it.

In the first embodiment shown in FIGS. 2A and 2B, the liquid-pervious layer 4 may be a nonwoven fabric having a low fiber density in which the fiber-to-fiber spaces serve as liquid guides; or the liquid-pervious layer 4 may be an apertured nonwoven fabric. In those cases, the preferred area ratio of the liquid guides or the apertures may be the same as in the above. Apart from those, the liquid-pervious layer 4 may be a network-structured sheet.

In the second embodiment shown in FIG. 3, both the top layer 4A and the back layer 4B may be an apertured nonwoven fabric; or the top layer 4A may be an apertured resin film and the back layer 4B may be an apertured nonwoven fabric or a nonwoven fabric having a low fiber density; or the back layer 4B may be an apertured resin film, and the top layer 4A may be a network-structured sheet.

In that case of using a network-structured sheet, the open area ratio of the meshes of the network structure of the sheet preferably falls within the range defined in the above.

### EXAMPLES

The invention is described in more detail with reference to the following Examples, which, however, are not intended to restrict the scope of the invention.

### Example 1

(Sample D):

Using a PP film for the liquid-pervious layer 4, and a through-air bonded nonwoven fabric for the liquid-absorbing layer 3, produced was a liquid-absorbent sheet comprising the layers 3 and 4.

The amount of the surfactant to be applied to or to be incorporated into the PP film was reduced so that the surface contact angle of the PP film could be at least 35°. 10% by weight of TiO₂ was added to the PP film so as to make the film cloudy, and the film thickness was 30 μm. The PP film was apertured to have round through-holes therein; the mean inner diameter of all the through-holes was 0.3 mm; and the mean pitch thereof was 8 mm in both MD (machine direction) and CD (cross direction). The area ratio of the through-holes in the film was 3%.

For the through-air bonded nonwoven fabric, used was sheath/core bicomponent fibers in which the sheath component is PE and the core component is PET. The basis weight of the fabric was 30 g/m². The bicomponent fibers to form the through-air bonded nonwoven fabric were coated with a surfactant.

### Comparative Example 1

(Sample A):

For the liquid-pervious layer 4, used was an apertured, foamed PP film; and for the liquid-absorbing layer 3, used was an air-laid pulp (nonwoven fabric of pulp alone).

The thickness of the foamed PP film was 50 μm; and the film was apertured in the same manner as in Example 1. The basis weight of the air-laid pulp was 60 g/m².

### Comparative Example 2

(Sample B):

For the liquid-pervious layer 4, used was the same PP film as in Example 1. Concretely, the PP film was apertured in the same manner as in Example 1, and its thickness was the same as in Example 1. However, the PP film used herein was coated with a surfactant in an ordinary manner. For the liquid-absorbing layer 3, used was the same through-air bonded nonwoven fabric as in Example 1.

### Comparative Example 3

(Sample C):

For the liquid-pervious layer 4, used was the same foamed PP film as in Comparative Example 1. For this, however, the basis weight of the film was reduced by 35%. For the liquid-absorbing layer 3, used was a liquid-absorbent polymer-containing nonwoven fabric. The nonwoven fabric was made of surfactant-coated synthetic fibers, and its basis weight was 18 g/m².

<Measurement of Surface Contact Angle>

1.8 μl of 0.9% physiological saline was dropped onto the surface of the liquid-pervious layer 4 of each sample, and drops 20 thus formed on the film surface were measured to determine the surface contact angle θ (see FIG. 6).

<Measurement of Liquid Retention on Film Surface>

One ml of 0.9% physiological saline was dropped onto the surface of the liquid-pervious layer 4 of each sample, which was then left as such for 1 minute. With that, the amount (g) of the physiological saline still remaining on the surface of the layer 4, not having penetrated therethrough, was measured. In addition, the surface appearance of the layer 4 was sensually checked as to how and to what degree the drips given to the layer 4 are visible.

<Measurement of the Width of Surface Liquid Absorption of Liquid-pervious Layer>

One ml of 0.9% physiological saline was dropped onto the surface of the liquid-pervious layer 4 of each sample. Having been thus applied to the layer 4, the saline around each through-hole of the layer 4 was absorbed by the underlying liquid-absorbing layer 3 via the through-hole. One minute after the saline dropping, the width between the peripheral edge of each through-hole and the end of the water spread around the through-hole was measured.

<Measurement of Charge Level>

Each sample of Example and Comparative Example was cut into a size of 40 mm×45 mm, and this sample piece was set on a sample stand of a charge level tester. The tester was discharged at 10 kV for 30 seconds to thereby make the sample piece electrostatically charged. Immediately after the discharging was stopped, the charge level of the sample piece was measured. The charge level decreases with the lapse of time. The maximum value of the charge level measured in that manner is referred to as the charge level of the sample thus tested herein. Accordingly, the charge level of the sample tested is equal to the charge level thereof just after having stopped the discharging operation.

<Test Data>

The test data are given in Table 1 below.

TABLE 1

| | | | | Width of Surface Liquid | |
|---|---|---|---|---|---|
| | Charge | Contact | Liquid | Absorption of Liquid- | Appearance of |
| Sample | Level (mV) | Angle (°) | Retention (g) | Pervious Layer (mm) | Drips |
| A (Comp. Ex. 1) | 3.57 | 3.50 | 0.072 | 0.040 | X |
| B (Comp. Ex. 2) | 6.75 | 26.00 | 0.014 | 0.059 | Δ |
| C (Comp. Ex. 3) | 8.33 | 29.06 | 0.008 | 0.183 | Δ |
| D (Example 1) | 10.35 | 42.70 | 0.003 | 0.352 | ◯ |

Appearance of Drips:
X: The drips spread broadly and were noticeable.
Δ: The drips were noticeable.
◯: The drips were negligible.

Appearance of Drips:

X: The drips spread broadly and were noticeable.

Δ: The drips were noticeable.

∘: The drips were negligible.

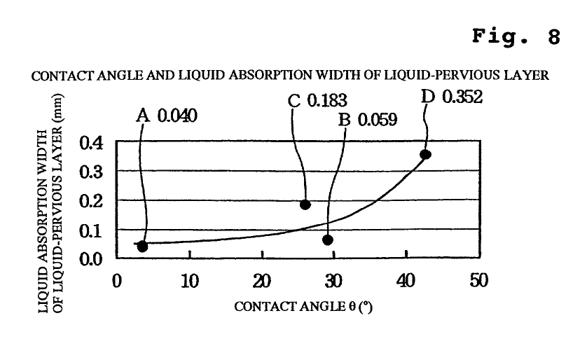

FIG. 7 is a graph showing the relationship between the surface contact angle and the liquid retention on the liquid-pervious layer of different liquid-absorbent sheets. FIG. 8 is a graph showing the relationship between the surface contact angle and the width of surface liquid absorption of the liquid-pervious layer of different liquid-absorbent sheets.

The samples A, B and D were analyzed for the charge level of three types, the liquid-pervious layer alone, the liquid-absorbing layer alone, and the laminate of the liquid-pervious layer and the liquid-absorbing layer (liquid-pervious layer+liquid-absorbing layer). The data are given in Table 2 below.

TABLE 2

| | Peak Value (mV) | | |
|---|---|---|---|
| | Liquid- | Liquid- | Liquid-pervious |
| | pervious | absorbing | Layer + Liquid- |
| | Layer alone | Layer alone | absorbing Layer |
| Sample A (Co. Ex. 1) | 3.70 | 0.01 | 3.57 |
| Sample B (Co. Ex. 2) | 12.38 | 0.01 | 6.75 |
| Sample D (Example 1) | 15.17 | 0.01 | 10.35 |

Table 1, FIG. 7 and FIG. 8 confirm the following: The liquid retention on the liquid-absorbing layer reduces with the increase in the surface contact angle θ; the liquid spread width reduces with the increase in the surface contact angle θ; and the liquid absorption width of the liquid-pervious layer increases with the increase in the surface contact angle θ. As in FIG. 7 and FIG. 8, the surface contact angle θ preferred for preventing the drip retention on the liquid-pervious layer is θ≧35°.

From Table 2, it is understood that the liquid-absorbent sheet 1, of which the charge level (peak value) of the liquid-pervious layer 4 alone is high but which is so designed that the liquid-pervious layer 4 of that type is laminated to the liquid-absorbing layer 3 of which the charge level is lower than that of the liquid-pervious layer 4, makes it possible to lower the charge level of the liquid-absorbent sheet 1 itself (liquid-pervious layer+liquid-absorbing layer) than the charge level of the liquid-pervious layer 4 alone.

As described in detail hereinabove with reference to its preferred embodiments, the liquid-absorbent sheet of the present invention, in which the surface of the liquid-pervious layer is made water-repellent, makes it possible to prevent the drip retention on the surface of the liquid-pervious layer. In addition, the liquid-absorbent sheet of the invention, in which the charge level of the liquid-absorbing layer is made lower than that of the liquid-pervious layer, makes it possible to reduce the electrostatic charge on the surface of the liquid-pervious layer and makes it possible to prevent dust adhesion to the liquid-pervious layer.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. A liquid-absorbent sheet for absorbing drips oozing from a food, comprising a laminate of a liquid-pervious layer and an underlying liquid-absorbing layer, the liquid-pervious layer having through-holes that serve as liquid guides capable of passing the drips therethrough, the liquid-absorbing layer being capable of absorbing the drips having passed through the liquid-pervious layer,
wherein the contact angle of a drop of physiological saline to the surface of the liquid-pervious layer is at least 35°, and the electrostatic chargeability of the liquid-absorbing layer is lower than that of the liquid-pervious layer.

2. The liquid-absorbent sheet as set forth in claim 1, wherein the liquid-pervious layer is in close contact with the liquid-absorbing layer.

3. The liquid-absorbent sheet as set forth in claim 1, wherein the liquid-pervious layer is a resin film having a plurality of through-holes formed therein, a nonwoven fabric or a network-structured sheet.

4. The liquid-absorbent sheet as set forth in claim 1, wherein the liquid-pervious layer is a resin film having a plurality of through-holes formed therein, and the liquid-absorbing layer is processed to have holes that communicate with the through-holes of the liquid-pervious layer.

5. The liquid-absorbent sheet as set forth in claim 1, wherein the liquid-absorbing layer is a liquid-retentive fibrous layer that comprises at least either of natural fibers and synthetic fibers.

6. The liquid-absorbent sheet as set forth in claim 5, wherein an antistatic agent is applied to the fibers of the liquid-absorbing layer.

7. The liquid-absorbent sheet as set forth in claim 1, wherein the electrostatic chargeability of the laminate of the liquid-pervious layer and the liquid-absorbing layer is lower than that of the liquid-pervious layer alone.

8. The liquid-absorbent sheet as set forth in claim 1, wherein the liquid-pervious layer comprises a top layer to directly receive a food on one side thereof and at least one back layer laminated to the other side of the top layer, and the electrostatic chargeability of the back layer is lower than that of the to player.

9. The liquid-absorbent sheet as set forth in claim 8, wherein the electrostatic chargeability of the top layer is higher than those of the back layer and the liquid-absorbing layer.

10. The liquid-absorbent sheet as set forth in claim 9, wherein at least the back layer and the liquid-absorbing layer contain an antistatic agent.

11. The liquid-absorbent sheet as set forth in claim 8, wherein the electrostatic chargeability of the laminate of the liquid-pervious layer and the liquid-absorbing layer is lower than that of the top layer alone.
